(19) United States
(12) Patent Application Publication
(10) Pub. No.: US 2019/0073182 A1
(43) Pub. Date: Mar. 7, 2019

(54) Wireless Speaker with Control for Selectable Channel

(71) Applicant: Yuzhan CHEN, Shenzhen (CN)

(72) Inventor: Yuzhan CHEN, Shenzhen (CN)

(21) Appl. No.: 15/696,884

(22) Filed: Sep. 6, 2017

(51) Int. Cl. G06F 3/16; H04W 72/04; H04R 1/02; H04R 3/12

(52) U.S. Cl. CPC G06F 3/165; H04W 72/0453; H04W 72/02; H04R 3/12; H04R 1/025

(57) ABSTRACT

A wireless speaker which includes a housing, a circuit board unit and a speaker unit. The circuit board unit comprises a main control module, a wireless communication module and a channel switch element. The wireless communication module wirelessly receives audio data and transmitting the audio data to the main control module in the form of an electrical signal. The channel switch element selects one or more playback channel and transmits the electrical signal to the main control module. The main control module selects an audio signal of the audio data which is corresponding to the selected playback channel of the channel switch element and loads the audio signal to the speaker unit. Based on the needs of a user, playback channel can be selected and the position of the wireless speaker is not restricted.

### BACKGROUND OF THE PRESENT INVENTION

### Field of Invention

The present invention relates to a speaker and, more particularly to wireless speaker with control for selectable channels and distributed interconnecting wireless speaker components.

### Description of Related Arts

Speakers are used to convert audio electrical signals into sound signals. With the rapid development of audio equipment, people become more and more demanding in different aspects such as sound quality, sound effects and user experience. The existing speaker equipment usually include one main control and two independent speakers in which the speakers are connected to the main control by connecting cables to achieve mono, stereo (two) and stereo mixing adjustment and control. However, in view of the limitation of cable length, each particular speaker can only be arranged within a small area. It is difficult to set the audio source at a particular direction as desired by an user and so these speakers fails to fully play to its optimized sound effects. Meanwhile, the conventional speakers are set in passive mode and their play channels can only be selected through front-end media device such as mobile phones and computers and etc. Accordingly, the use of the speakers is not flexible and fails to achieve flexible selection for play channel, thus the market need is not fulfilled.

### SUMMARY OF THE PRESENT INVENTION

An object of the present invention is to solve the above problems and provide a wireless speaker with control for selectable channels and distributed interconnecting wireless speaker system which is capable of selecting the play channel based on the need of a user while the position of the speaker is not limiting but convenience such that a number of play requirements are met at the same time.

Additional advantages and features of the invention will become apparent from the description which follows, and may be realized by means of the instrumentalities and combinations particular point out in the appended claims.

According to the present invention, the foregoing and other objects and advantages are attained by a wireless speaker with control for selectable channels which comprises: a housing, a circuit board unit and a speaker unit mounted inside the housing, wherein the circuit board unit comprises a main control module, a wireless communication module and a channel switch element, wherein the speaker unit, the wireless communication module and the channel switch element are electrically connected to the main control module respectively, wherein the wireless communication module wirelessly receives audio data and transmitting the audio data to the main control module in the form of an electrical signal, the channel switch element selects one or more playback channel and transmits the electrical signal to the main control module, wherein the main control module selects an audio signal of the audio data which is corresponding to the selected playback channel of the channel switch element and loads the audio signal to the speaker unit.

Preferably, the channel switch element is a press button provided on the housing.

Preferably, the housing comprises a front housing member; and a rear housing member coupled with the front housing member to form the housing.

Preferably, the rear housing member comprises a power plug provided thereon arranged for connecting to a power socket of a power source, wherein the circuit board unit comprises a voltage regulator module provided thereon and electrically connected to the power plug, wherein the voltage regulator module is arranged for converting a main voltage from the power source into a DC supply voltage for power supply to the circuit board unit.

Preferably, the circuit board unit comprises a card slot thereon, which is arranged for inserting a SD card with stored audio data.

Preferably, the housing comprises a battery unit therein which is electrically connected to an output terminal of the voltage regulator module such that the battery unit is charged by current output from the voltage regulator module.

Preferably, the speaker unit comprises two speaker members which are positioned at the front housing member and the rear housing member respectively.

Preferably, the circuit board unit comprises a radio module and the housing comprises an antenna, wherein the radio module is electrically connected between the antenna and the main control module.

The present invention also provides a distributed interconnecting wireless speaker system, which comprises at least two wireless speakers with control for selectable channel, wherein each of the wireless speakers with control for selectable channel comprises: a housing, a circuit board unit and a speaker unit mounted inside the housing, wherein the circuit board unit comprises a main control module, a wireless communication module and a channel switch element, wherein the speaker unit, the wireless communication module and the channel switch element are electrically connected to the main control module respectively, wherein the wireless communication module wirelessly receives audio data and transmitting the audio data to the main control module in the form of an electrical signal, the channel switch element selects one or more playback channel and transmits the electrical signal to the main control module, wherein the main control module selects an audio signal of the audio data which is corresponding to the selected playback channel of the channel switch element and loads the audio signal to the speaker unit.

Preferably, the at least two wireless speakers transmit audio data between each other through the wireless communication module.

According to the wireless speaker with control for selectable channels of the present invention, wireless communication module are utilized to receive wireless audio data transmitted from upper level playback device such as mobile phones and tablet computer. When used, a user can select the playback channel through the channel switch to select a left channel, a right channel or a mixing stereo channel. Also, since the speaker is not limited by a length of a connecting cable, the speaker can be positioned at any desire location and the user can obtain sound from a particular direction and a particular channel. In particular, when a plurality of wireless speakers are used together, stereo sound effects with multi-directional and surround sound effects can be achieved. When only one speaker is used by the user, a mixed stereo mode can be set through the channel switch, that is to say, the speaker can be used as a single portable wireless speaker. In view of the above features, it can be seen that the speaker of the present invention can play the selected channel based on the need of the user while the location of the speaker can be conveniently arranged, thus meeting the needs of different playback requirements and the user experience can be increased dramatically.

Still further objects and advantages will become apparent from a consideration of the ensuing description and drawings. These and other objectives, features, and advantages of the present invention will become apparent from the following detailed description, the accompanying drawings, and the appended claims.

### BRIEF DESCRIPTION OF THE DRAWINGS

FIG. 1 is a perspective view illustration of a speaker according to a preferred embodiment of the present invention.

FIG. 2 is an exploded view illustration of the speaker according to the above preferred embodiment of the present invention.

FIG. 3 is another perspective view illustration of a speaker according to the above preferred embodiment of the present invention.

FIG. 4 is another exploded view illustration of the speaker according to the above preferred embodiment of the present invention.

FIG. 5 is a schematic circuit diagram of the circuit board according to the above preferred embodiment of the present invention.

### DETAILED DESCRIPTION OF THE PREFERRED EMBODIMENT

The preferred embodiment of the present invention is further described with the accompanying drawings as follows.

### Embodiment 1

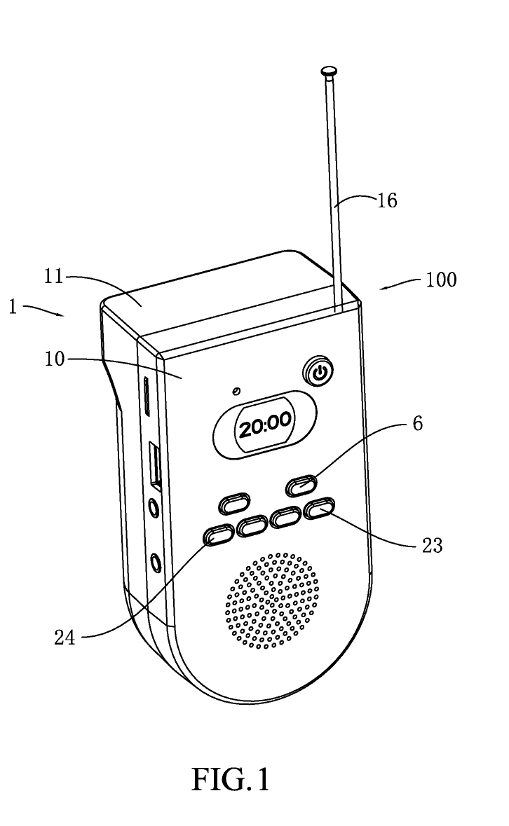

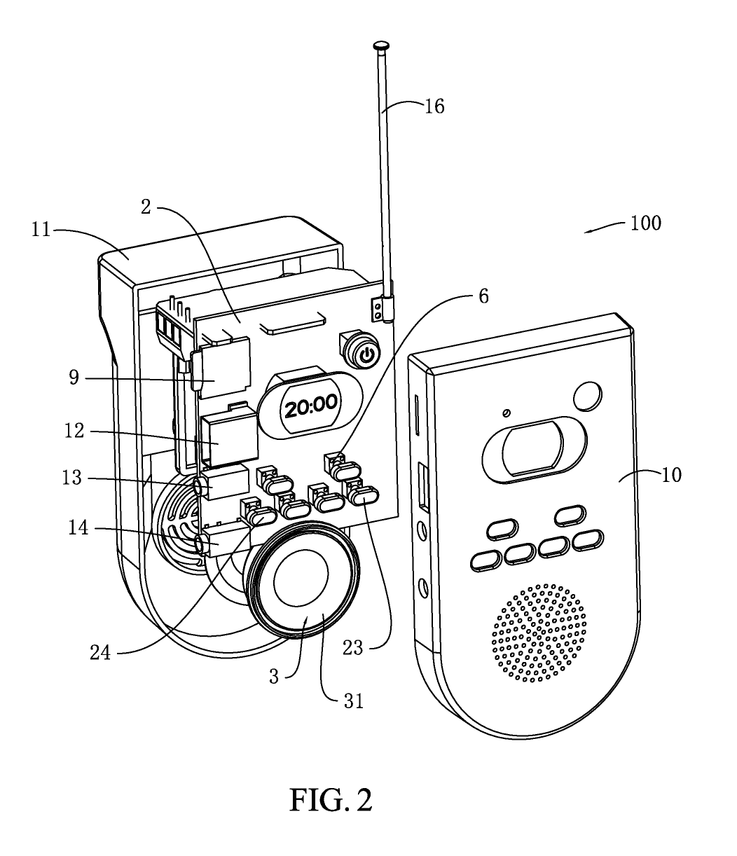

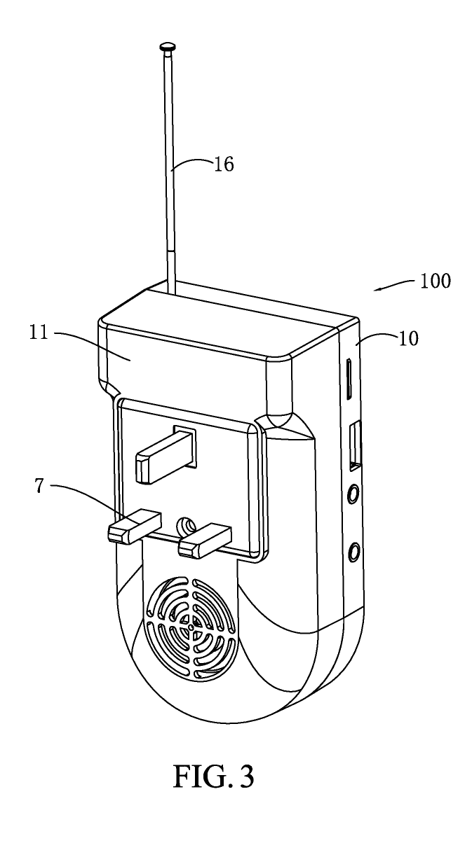

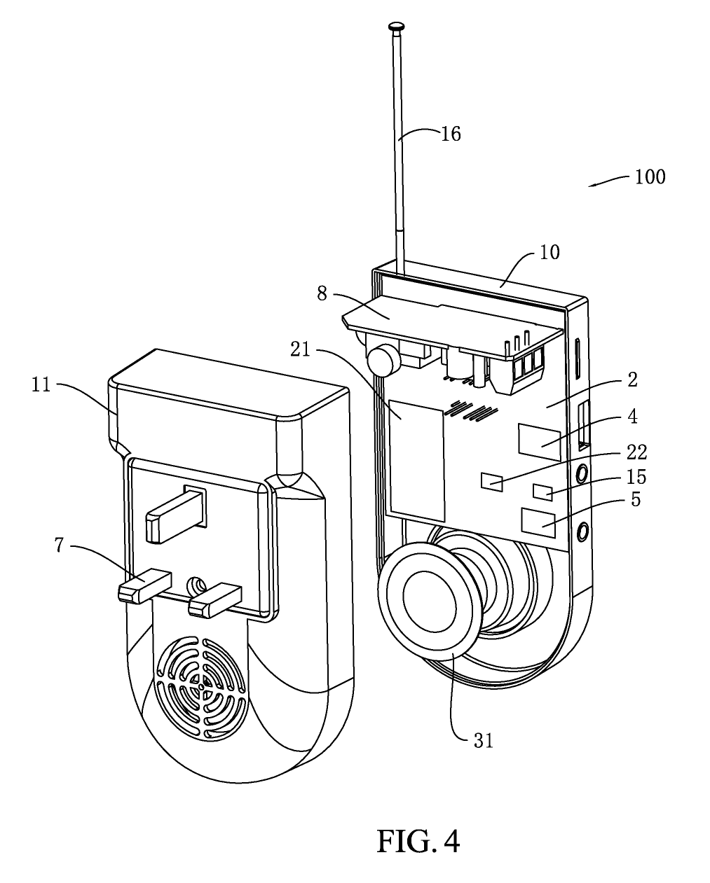

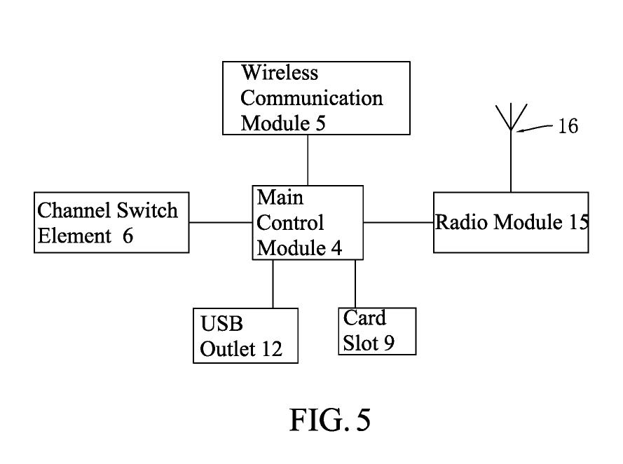

Referring to FIG. 1 to FIG. 5 of the drawings, the wireless speaker 100 with control for selectable channel according to this preferred embodiment of the present invention comprises a housing 1, a circuit board unit 2 and a speaker unit 3 inside the housing 1, wherein the circuit board unit 2 comprises a main control module 4, a wireless communication module 5 and a channel switch element 6, wherein the speaker unit 3, wireless communication module 5 and the channel switch element 6 are electrically connected to the main control module 4 respectively, the wireless communication module 5 is arranged for wirelessly receiving audio data and transmitting the audio data to the main control module 4 in the form of an electrical signal, the channel switch element 6 is arranged for selecting play channel and transmitting an electrical signal to the main control module 4, the main control module 4 is arranged for loading an audio signal of the audio data which is corresponding to the selected play channel of the channel switch element 6 to the speaker unit 3.

In the above wireless speaker 100, the wireless communication module 5 is utilized to receive wireless audio data transmitted from a playback device, such as mobile phone and tablet computer. When used, a user can switch the play channel such as left channel, right channel or mixed stereo through the channel switch element 6. Also, since the wireless speaker 100 is not limited by a length of a connecting cable, the wireless speaker 100 can be placed at any location. Thus, the user is able to obtain sound from a particular direction and a particular channel. In particular, when a plurality of wireless speakers 100 are used together, stereo sound effects with multi-directional and surround sound effects can be achieved. When only one wireless speaker 100 is used by the user, a mixed stereo mode can be set through the channel switch element 6. That is to say, the wireless speaker 100 can be used as a single portable wireless speaker. In view of the above features, it can be seen that the wireless speaker of the present invention can play the selected channel based on the need of the user while the location of the speaker can be conveniently arranged, thus meeting the needs of different playback requirements and the user experience can be increased dramatically.

Preferably, the channel switch element 6 is a press button mounted on the housing 1. However, this is merely a preferred embodiment and the channel switch element 6 can also be implemented as a gear switch, a toggle switch or a rotary switch.

According to the preferred embodiment of the present invention, the housing 1 comprises a front housing member 10; and a rear housing member 11 coupled with the front housing member 10. Wherein the rear housing member 11 comprises a power plug 7 provided thereon arranged for connecting to a power socket of a power source, the circuit board unit 2 comprises a voltage regulator module 8 provided thereon and electrically connected to the power plug 7. The voltage regulator module 8 is arranged for converting a main voltage from the power source into a DC supply voltage for providing power to the circuit board unit 2. With the arrangement of the power plug 7, the wireless speaker 100 can be plugged into any power socket, such as an indoor wall socket, to obtain power. Therefore, this arrangement of power plug 7 not only provide convenience in obtaining power supply, but also facilitate setting different wireless speakers 100 independently at different locations. Therefore, multi-directional sound output can be achieved.

Preferably, the housing 1 comprises a battery unit 21 which is electrically connected to an output terminal of the voltage regulator module 8 such that the battery unit 21 is charged by current output from the voltage regulator module 8.

Preferably, the circuit board unit 2 comprises a USB outlet 12 which is arranged for data input and for providing power supply to an external device. When the USB outlet 12 is connected to an external device, the power output from the battery unit 21 can be used to charge the external device such as mobile phone. The specific operating mode of the USB outlet 12 is selected and set through the main control module 4. In addition, the circuit board unit 2 comprises a headphone jack 13 and an audio input socket 14.

According to the preferred embodiment of the present invention, the circuit board unit 2 comprises a card slot 9 in which a SD card for storing audio data is inserted therein. Preferably, the circuit board unit 2 comprises an audio decoding module 22 arranged for decoding and playing the data stored in the SD card. The front housing member 10 comprises a volume key 23 and a selection key 24 arranged for playing local audio file.

The speaker unit 3 comprises two speaker members 31 which are positioned at the front housing member 10 and the rear housing member 11 respectively.

In order to receive the FM broadcasting signal, the circuit board unit 2 comprises a radio module 15, the housing 1 comprises an antenna 16. The radio module 15 is electrically connected between the antenna 16 and the main control module 4.

The advantageous effect of the present invention is that the wireless speaker 100 can be used independently as a single unit; or a plurality of wireless speakers 100 can be used together and controlled by an upper level device such as a mobile phone simultaneously so as to achieve sound output at multiple location and particular sound channel.

### Embodiment 2

Referring to FIG. 1 to FIG. 5 of the drawings, the wireless speaker with control for selectable channel according to this preferred embodiment of the present invention comprises at least two wireless speakers 100. The wireless speaker 100 comprises a housing 1, a circuit board unit 2 and a speaker unit 3 inside the housing 1, wherein the circuit board unit 2 comprises a main control module 4, a wireless communication module 5 and a channel switch element 6, wherein the speaker unit 3, wireless communication module 5 and the channel switch element 6 are electrically connected to the main control module 4 respectively, the wireless communication module 5 is arranged for wirelessly receiving audio data and transmitting the audio data to the main control module 4 in the form of an electrical signal, the channel switch element 6 is arranged for selecting play channel and transmitting an electrical signal to the main control module 4, the main control module 4 is arranged for loading an audio signal of the audio data which is corresponding to the selected play channel of the channel switch element 6 to the speaker unit 3.

The difference between this embodiment 2 and the above embodiment 1 is that, the wireless speakers 100 transmit audio data between each other through the wireless communication module 5.

Accordingly, audio data can be shared between different wireless speakers of the present invention. Based on the channel setting, audio data at particular direction and particular channel can be achieved and hence sound effect with stereo surround sound can be achieved.

According to the wireless speaker with control for selectable channels and distributed interconnecting wireless speaker components of the present invention, the playback channel can be selected based on the need of the user while the location of the speaker can be conveniently arranged, thus greatly fulfilling the different play needs of the user. In addition, based on the above two embodiments, the present invention also provides one control for multiple speakers, and sharing network layout with multiple controls for multiple speakers. Therefore, the present invention can play a role in different applications, fit the needs of contemporary users, fit for promotion and applications in audio playback and output equipment, and have a relatively good market prospects.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wireless speaker with control for selectable channel, comprising: a housing, a circuit board unit and a speaker unit mounted inside said housing, wherein said circuit board unit comprises a main control module, a wireless communication module and a channel switch element, wherein said speaker unit, said wireless communication module and said channel switch element are electrically connected to said main control module respectively, wherein said wireless communication module wirelessly receives audio data and transmitting the audio data to said main control module in the form of an electrical signal, said channel switch element selects one or more playback channel and transmits the electrical signal to said main control module, wherein said main control module selects an audio signal of the audio data which is corresponding to the selected playback channel of the channel switch element and loads the audio signal to said speaker unit.

2. The wireless speaker according to claim 1, wherein said channel switch element is a press button provided on said housing.

3. The wireless speaker according to claim 1, wherein said housing comprises a front housing member; and a rear housing member coupled with said front housing member to form said housing.

4. The wireless speaker according to claim 3, wherein said rear housing member comprises a power plug provided thereon arranged for connecting to a power socket of a power source, wherein said circuit board unit comprises a voltage regulator module provided thereon and electrically connected to the power plug, wherein said voltage regulator module is arranged for converting a main voltage from the power source into a DC supply voltage for power supply to said circuit board unit.

5. The wireless speaker according to claim 1, wherein said circuit board unit comprises a card slot thereon, which is arranged for inserting a SD card with stored audio data.

6. The wireless speaker according to claim 4, wherein said circuit board unit comprises a card slot thereon, which is arranged for inserting a SD card with stored audio data.

7. The wireless speaker according to claim 4, wherein said housing comprises a battery unit therein which is electrically connected to an output terminal of said voltage regulator module such that said battery unit is charged by current output from said voltage regulator module.

8. The wireless speaker according to claim 6, wherein said housing comprises a battery unit therein which is electrically connected to an output terminal of said voltage regulator module such that said battery unit is charged by current output from said voltage regulator module.

9. The wireless speaker according to claim 3, wherein said speaker unit comprises two speaker members which are positioned at said front housing member and said rear housing member respectively.

10. The wireless speaker according to claim 4, wherein said speaker unit comprises two speaker members which are positioned at said front housing member and said rear housing member respectively.

11. The wireless speaker according to claim 6, wherein said speaker unit comprises two speaker members which are positioned at said front housing member and said rear housing member respectively.

12. The wireless speaker according to claim 1, wherein said circuit board unit comprises a radio module and said housing comprises an antenna, wherein said radio module is electrically connected between said antenna and said main control module.

13. The wireless speaker according to claim 3, wherein said circuit board unit comprises a radio module and said housing comprises an antenna, wherein said radio module is electrically connected between said antenna and said main control module.

14. The wireless speaker according to claim 4, wherein said circuit board unit comprises a radio module and said housing comprises an antenna, wherein said radio module is electrically connected between said antenna and said main control module.

15. The wireless speaker according to claim 6, wherein said circuit board unit comprises a radio module and said housing comprises an antenna, wherein said radio module is electrically connected between said antenna and said main control module.

16. The wireless speaker according to claim 11, wherein said circuit board unit comprises a radio module and said housing comprises an antenna, wherein said radio module is electrically connected between said antenna and said main control module.

17. A distributed interconnecting wireless speaker system, which comprises at least two wireless speakers with control for selectable channel, wherein each said wireless speaker with control for selectable channel comprises: a housing, a circuit board unit and a speaker unit mounted inside said housing, wherein said circuit board unit comprises a main control module, a wireless communication module and a channel switch element, wherein said speaker unit, said wireless communication module and said channel switch element are electrically connected to said main control module respectively, wherein said wireless communication module wirelessly receives audio data and transmitting the audio data to said main control module in the form of an electrical signal, said channel switch element selects one or more playback channel and transmits the electrical signal to said main control module, wherein said main control module selects an audio signal of the audio data which is corresponding to the selected playback channel of the channel switch element and loads the audio signal to said speaker unit.

18. The distributed interconnecting wireless speaker system, according to claim 17, wherein said at least two wireless speakers transmit audio data between each other through said wireless communication module.
